(19) United States
(12) Patent Application Publication
(10) Pub. No.: US 2026/0312478 A1
(43) Pub. Date: Oct. 8, 2026

(54) POWER SUPPLY CIRCUIT AND POWER SUPPLY CHIP

(71) Applicant: SHANGHAI XINLONG SEMICONDUCTOR TECHNOLOGY CO., LTD., Pudong New Area, Shanghai (CN)

(72) Inventors: Bin LIU, Shanghai (CN); Ruiping LI, Shanghai (CN)

(73) Assignee: SHANGHAI XINLONG SEMICONDUCTOR TECHNOLOGY CO., LTD., Pudong New Area, Shanghai (CN)

(21) Appl. No.: 19/481,365

(22) PCT Filed: Sep. 3, 2024
(86) PCT No.: PCT/CN2024/116541

§ 371 Date: Nov. 4, 2025

(30) Foreign Application Priority Data
Apr. 22, 2024 (CN) 202410479300.6

(51) Int. Cl. H02M 1/00; H02M 1/088; H02M 3/156; H02M 3/157; H02M 3/158

(52) U.S. Cl. CPC H02M 1/0048; H02M 1/088; H02M 3/1566; H02M 3/157; H02M 3/158

(57) ABSTRACT

The present invention provides a power supply circuit and power supply chip. The power supply circuit includes a logic sub-circuit and a drive sub-circuit. The drive sub-circuit is configured to drive a power transistor and is connected in series with the logic sub-circuit so that the two commonly share at least part of a current. With this arrangement, the series-connection power supply path allows for current sharing between the logic and drive sub-circuits, which can significantly reduce the chip's inherent circuit losses. Moreover, this optimizes the chip from the perspective of circuit structure, lowering its own power consumption. In some embodiments of the invention, the series-connection-based design is adapted to various scenarios, achieving additional improvements in reliability and practicality.

### TECHNICAL FIELD

The present invention relates to the field of power supply chips, and more particularly to a power supply circuit and power supply chip.

### BACKGROUND

Switched-mode power supply (SMPS) chips, which are primarily used for power conversion, such as voltage boosting, voltage bucking, or both, usually incorporate power triodes or MOS transistors as power transistors. A buck-type SMPS chip typically incorporates both PMOS and NMOS transistors as power transistors, which are arranged in two separate drive circuits. There have been proposed a variety of solutions for enhancing the conversion efficiency of power supply chips, among which, reducing their own power consumption is mostly adopted.

Most existing optimization schemes rely on the selection and use of electrical components with improved electrical parameters, but there are rare schemes established by modifying the circuit structure of power supply chips. That is, there is a lack of conventional optimization solutions for reducing a chip's power consumption from the perspective of the chip's own circuit structure.

### SUMMARY

It is an object of the present invention to provide a structurally optimized power supply circuit and a power supply chip, which incorporates the circuit and is thereby advantageously reduced in power consumption due to the structural optimization of the circuit.

To this end, the present invention provides a power supply circuit including a logic sub-circuit and a drive sub-circuit. The drive sub-circuit is configured to drive a power transistor, and the logic and drive sub-circuits are connected in series so as to share at least part of a current.

The drive sub-circuit is configured to charge a clamping capacitor. The clamping capacitor is configured to store charge in an amount sufficient to quickly charge parasitic capacitance of the power transistor and hence rapidly turn on the power transistor with a charge current, at least 90% of which is commonly shared by the logic and drive sub-circuits.

Optionally, the drive sub-circuit may include a first voltage terminal, a second voltage terminal and a current output terminal, the first voltage terminal configured for connection with an input voltage, wherein the clamping capacitor is connected between the first and second voltage terminals, and
during normal operation of the power transistor, at least 90% of the charge current flows successively through the first voltage terminal, the clamping capacitor, the second voltage terminal, the current output terminal and the logic sub-circuit.

Optionally, the drive sub-circuit may include a clamping module, wherein the first voltage terminal, the second voltage terminal and the current output terminal are all terminals of the clamping module; the clamping module includes a first current output unit and a second current output unit; an output terminal of the first current output unit and an output terminal of the second current output unit are connected to each other and together provide the current output terminal;
the first current output unit is configured to transfer at least 90% of the charge current to the logic sub-circuit during normal operation of the power transistor; and the second current output unit is configured to provide a current necessary for operation of the logic sub-circuit when the power transistor is out of normal operation.

Optionally, the first current output unit may also be configured to keep the second current output unit out of operation, or minimize its energy consumption, during normal operation of the power transistor.

Optionally, the first current output unit may include a first voltage regulator diode, a first switching element and a first constant current source, a cathode of the first voltage regulator diode connected to the first voltage terminal, an input terminal of the first switching element connected to the second voltage terminal, a control terminal of the first switching element connected to an anode of the first voltage regulator diode, an output terminal of the first switching element serving as the output terminal of the first current output unit, an input terminal of the first constant current source connected to the control terminal of the first switching element, an output terminal of the first constant current source being grounded,
wherein the first switching element is turned on if a voltage difference between the control and input terminals of the first switching element reaches a predetermined value, and otherwise remains off.

Optionally, the second current output unit may include a second voltage regulator diode and a second switching element, a cathode of the second voltage regulator diode connected to the first voltage terminal, an anode of the second voltage regulator diode connected to a control terminal of the second switching element, an input terminal of the second switching element connected to the first voltage terminal, the output terminal of the second switching element serving as the output terminal of the second current output unit,
wherein the second switching element is turned on if a voltage difference between the control and input terminals of the second switching element reaches a predetermined value, and otherwise remains off, and
wherein a first voltage, which is a voltage present on the output terminal of the first switching element after it is turned on, is higher than a second voltage, which is a voltage present on the output terminal of the second switching element after it is turned on and the first switching element is turned off.

Optionally, the clamping module may further include a third current output unit, which is configured, when the charge current is greater than the current necessary for normal operation of the logic sub-circuit, to directly output part of the charge current to the ground so that the remainder of the charge current matches the logic sub-circuit.

Optionally, the third current output unit may include a third switching element and a control component, wherein: a terminal of the third switching element is connected to both the second voltage terminal and ground; and
the control component is configured to: turn on the third switching element when the third switching element is off and a voltage difference between the first and second voltage terminals is smaller than a first voltage difference; and turn off the third switching element when the third switching element is on and the voltage difference between the first and second voltage terminals is greater than a second voltage difference, wherein the first and second voltage differences are determined based on voltages required for normal operation of the power transistor, and the first voltage difference is lower than the second voltage difference.

To the above end, the present invention also provides a power supply chip including the power supply circuit as defined above.

To sum up, the present invention provides a power supply circuit and power supply chip. The power supply circuit includes a logic sub-circuit and a drive sub-circuit. The drive sub-circuit is configured to drive a power transistor and is connected in series with the logic sub-circuit so that the two commonly share at least part of a current. With this arrangement, the series-connection power supply path allows for current sharing between the logic and drive sub-circuits, which can significantly reduce the chip's inherent circuit losses. Moreover, this optimizes the chip from the perspective of circuit structure, lowering its own power consumption. In some embodiments of the invention, the series-connection-based design is adapted to various scenarios, achieving additional improvements in reliability and practicality.

### BRIEF DESCRIPTION OF THE DRAWINGS

Those of ordinary skill in the art will understand that the following drawings are presented to enable a better understanding of the present invention and not intended to limit the scope thereof in any sense, in which:

FIG. 1 is a schematic diagram showing the internal structure of a conventional power supply chip;

FIG. 2 is a schematic diagram showing the internal structure of a power supply chip according to an embodiment of the present invention;

FIG. 3 is a schematic diagram showing the internal structure of a clamping module according to an embodiment of the present invention; and

FIG. 4 is a schematic diagram showing the internal structure of a clamping module according to another embodiment of the present invention.

### LIST OF REFERENCE NUMERALS

100 power supply chip; 200 power supply chip;
1 logic sub-circuit; 2 drive sub-circuit; 3 power transistor; 4 drive sub-circuit; 101 startup and regulation module; 102 logic function module; 103 clamping module; 104 drive module; 203 clamping module; 1021 error amplifier; 1022 compensation unit; 1023 comparator; 1024 oscillator; 1025 overcurrent protection unit; 1026 latch; 1027 overtemperature protection unit;
2031 first voltage terminal; 2032 second voltage terminal; 2033 current output terminal; 2034 first current output unit; 2035 second current output unit; 2036 third current output unit; 2037 control component.

### DETAILED DESCRIPTION

Objects, advantages and features of the present invention will become more apparent upon reading the following more detailed description of specific embodiments thereof in conjunction with the accompanying drawings. Note that the figures are provided in a very simplified form not necessarily drawn to exact scale for the only purpose of helping explain embodiments of the invention disclosed herein in a more convenient and clearer way. In addition, the illustrated structures are usually part of their real-world counterparts. In particular, as the figures tend to have distinct emphases, they are sometimes drawn to different scales.

As used herein, the singular forms “a”, “an” and “the” include plural referents, and the term “or” is generally employed in the sense of “and/or”, “a number of” of “at least one”, and “at least two” of “two or more”. Additionally, the use of the terms “first”, “second” and “third” herein is intended to be illustrative only and is not to be construed as denoting or implying relative importance or as implicitly indicating the number of the referenced items. Accordingly, defining an item with “first”, “second” or “third” is an explicit or implicit indication of the presence of one or at least two such items. The terms “one end” and “other end”, as well as “proximal end” and “distal end”, may be used herein to generally refer to opposite end portions including the endpoints, rather than only to the endpoints. The terms “mounting”, “coupling”, “connecting” and any variants thereof should be interpreted in a broad sense. For instance, a connection may be a permanent, detachable or integral connection, or a direct or indirect connection with one or more intervening media, or an internal communication or interaction between two elements. When an element is referred to as being “disposed” on another element, this is generally intended to only mean that there is a connection, coupling, engagement or transmission relationship between the two elements, which may be either direct or indirect with one or more intervening elements, and should not be interpreted as indicating or implying a particular spatial position relationship between them. That is, the element may be located inside, outside, above, under, beside, or at any other location relative to the other element, unless the context clearly dictates otherwise. Those of ordinary skill in the art can understand the specific meanings of the above-mentioned terms herein, depending on their context.

It is a principal object of the present invention to provide a structurally optimized power supply circuit and a power supply chip, which incorporates the circuit and is thereby advantageously reduced in power consumption due to the structural optimization of the circuit.

Further description is set forth below with reference to the accompanying drawings.

Power circuits described herein are proposed on the basis of the inventor's in-depth analysis of the prior art.

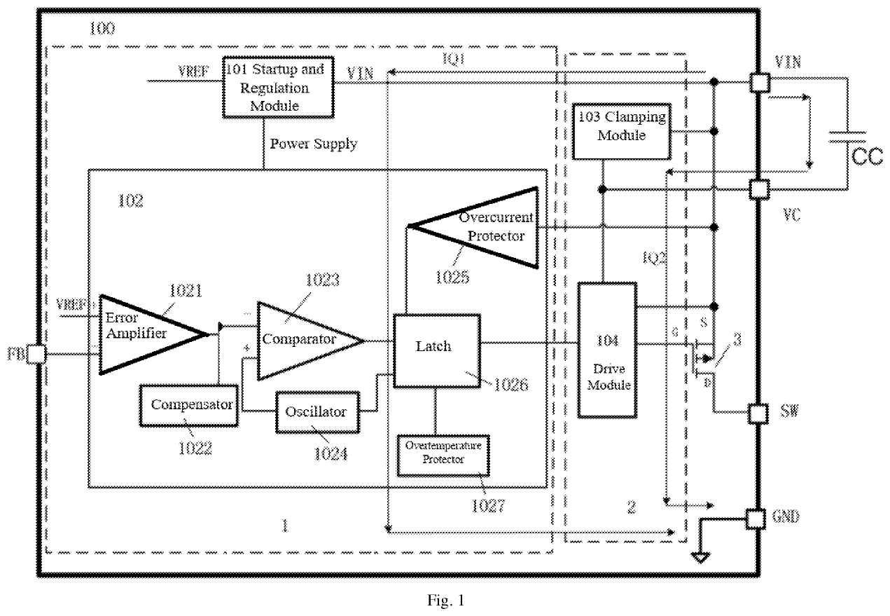

Reference is now made to FIG. 1, which illustrates a power supply circuit incorporated in a conventional power supply chip 100. The power supply circuit includes a logic sub-circuit 1 and a drive sub-circuit 2. The logic sub-circuit 1 includes a startup and regulation module 101 and a logic function module 102. The drive sub-circuit 2 includes a clamping module 103 and a drive module 104. Specifically, the logic function module 102 includes an error amplifier 1021, a compensation unit 1022, a comparator 1023, an oscillator 1024, an overcurrent protection unit 1025, a latch 1026 and an overtemperature protection unit 1027. These components and modules provide functions as their names suggest. The drive sub-circuit 2 is used to drive a power transistor 3.

The power supply chip 100 further includes a power transistor 3 and VIN, VC, SW, GND and FB pins. The VC and VIN pins are configured for connection with a clamping capacitor CC, and the SW pin is configured for output of a voltage therefrom. The FB pin is configured to obtain a feedback voltage, and the GND pin is configured to be grounded. The VIN pin is also configured to obtain input power.

In the conventional power supply chip 100, the logic sub-circuit 1 and the drive sub-circuit 2 are connected in parallel to receive power. Therefore, losses of the two modules both contribute to the inherent loss of the chip, making the latter significant.

The chip itself consumes much power. Consequently, when operating at a high voltage, it provides limited output power and experiences a considerable temperature increase due to significant power consumption. Moreover, increasing the output power will further raise the chip temperature due to an additional conversion loss, possibly leading to operation of the chip at an excessively high temperature, which is detrimental to its reliability. Therefore, the output power is typically limited under high input voltage conditions. Generally, efficiency can be improved under light load conditions by lowering the switching frequency because this can reduce the loss of the circuit that drives the power transistor and hence the inherent loss. However, the chip may be associated with greater ripple in its output voltage at a lower switching frequency, which may deteriorate its response to transient load changes and hence impair its performance.

Therefore, in order to achieve a power supply system-on-chip with higher conversion efficiency under light load conditions, greater high temperature resistance and increased output power under high input voltage conditions, it is crucial to additionally reduce the chip's inherent power consumption.

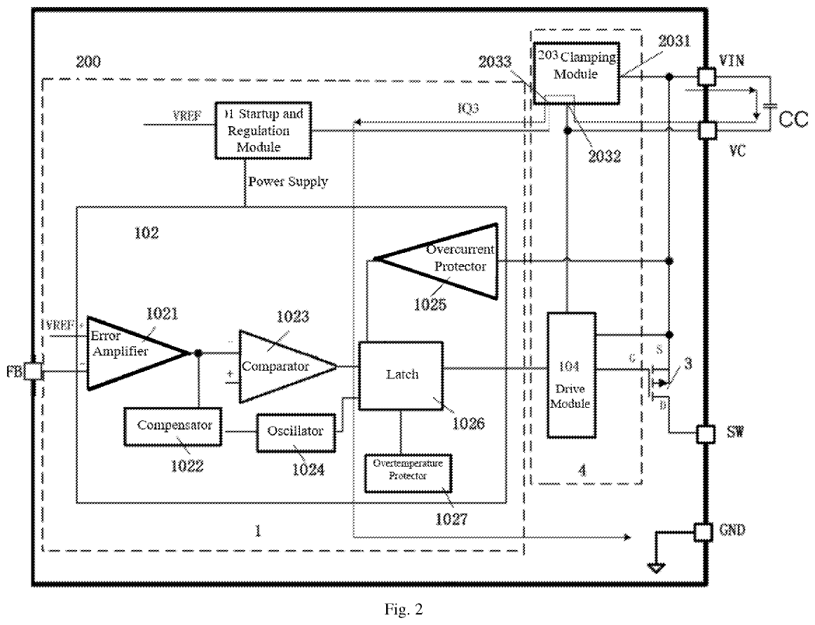

Referring to FIG. 2, embodiments described herein provide a power supply chip 200 including a power supply circuit. The power supply circuit includes a logic sub-circuit 1 and a drive sub-circuit 4. The drive sub-circuit 4 is configured to drive a power transistor 3 and is connected in series with the logic sub-circuit 1 so as to commonly share at least part of a current.

The power supply chip of FIG. 2 may be similar to that of FIG. 1 in terms of the modules' naming, functionality and internal structures except that including a clamping module 203 that is different from the clamping module 103 of FIG. 1. Besides, the modules of FIG. 2 may be wired in a different way than those of FIG. 1. Specifically, in contrast to the startup and regulation module 101 of FIG. 1 that gets power from the VIN pin, the startup and regulation module 101 of FIG. 2 may source power from a current output terminal of the clamping module 203.

Despite a high drain-source voltage, the MOS transistor (i.e., the power transistor 3) usually has a gate-source voltage of only 20 V or lower. In order to impart higher voltage resistance to the power supply chip, rapid turn-on or -off of the MOS transistor in the chip is necessary and may require the use of a dedicated drive circuit for the transistor. However, due to large input (C_{ISS}) or output (C_{OSS}) parasitic capacitance of the power MOS transistor, it must be charged with a peak gate-source current on the order of one hundred mA, thereby tuning the gate-source voltage of the MOS transistor into a predetermined range, as soon as it is turned on. Once this is attained, the gate-source voltage of the turned-on power transistor can be maintained at a very small current. Likewise, in order to turn off the power MOS transistor, rapid discharge of the gate-source voltage is necessary. Therefore, the power transistor consumes a fixed amount of electrical current in each switching cycle, whose average value is related to the MOS transistor's parasitic capacitance.

According to the most popular conventional scheme, the logic and drive sub-circuits in the chip are separately powered. However, this is disadvantageous in that both the sub-circuits cause losses, which contribute to the chip's inherent loss and affect its conversion efficiency, in particular under light load conditions and high input voltage conditions. Although the conversion efficiency of the power supply chip can be improved by reducing the inherent power consumption of the logic sub-circuit, and optionally the loss caused by the drive sub-circuit for the power transistor, when either of the losses is reduced below some limit, the power supply chip may lose its ability to allow for a wide voltage range, a large output current and/or the use of a large output power transistor.

In embodiments described herein, a novel circuit topology is proposed, in which the logic and drive sub-circuits are connected in series so as to achieve current sharing in their operation, resulting in significant reductions in the chip's inherent loss. Through reducing the chip's own power consumption, its performance under high input voltage conditions can be improved times (since the chip's inherent loss is equal to the input voltage times the static current, reducing the current enables the chip to consume much less power, generate much less heat, provide more output power and operate more stably under high input voltage conditions). Meanwhile, conversion efficiency of the chip under light load conditions can be improved (since the chip's own power consumption accounts for a greater proportion due to lower output power under such conditions, reducing its power consumption means significantly increased efficiency).

Specifically, the drive sub-circuit 4 is configured to charge the clamping capacitor CC, and the clamping capacitor CC can store a sufficient amount of electricity required to quickly charge the parasitic capacitance of the power transistor 3 to enable rapid turn-on of power transistor. At least 90% of the charge current for the clamping capacitor CC is shared by the logic sub-circuit 1 and the drive sub-circuit 4.

Here, as will be understood, the charge current is an average value, and the percentage (90%) is a value averaged over a period of time, but not a value fixed at any instant of time. Generally speaking, parameters are suitably selected so that the charge current during stable operation of the power supply chip is equal to an operating current of the startup and regulation module 101. However, under specific operating conditions (e.g., during startup), or depending on where the power supply chip is used, the charge current may be greater than or smaller than the operating current of the startup and regulation module 101. In the former case, it is necessary to otherwise increase the operating current (or otherwise eliminate the surplus of the charge current). In the latter case, it is necessary to otherwise increase the charge current.

According to embodiments described herein, through current sharing, the loss caused by one of the sub-circuits can be avoided, greatly reducing the chip's inherent loss. This results in improved output power of the chip under high input voltage conditions and increased conversion efficiency thereof under light load conditions. Specifically, the performance of the power supply chip can be significantly enhanced in the input voltage range of from 8 V to 120 V.

Operation of the circuit is detailed below.

The logic sub-circuit is typically associated with a fixed minimum necessary current for its operation. That is, it can operate at a current equal to or above the minimum necessary current. The logic circuit is generally used to detect parameters such as output voltage, current and operating temperature and to control the drive module for the power transistor to ensure proper operation of the chip. It usually operates at a low voltage (typically about 2 to 3 V, much lower than the chip's input voltage) although it indeed does not require any particular power supply voltage. Typically, it is necessary for the power transistor in the chip to be switched on or off with a drive current that is equal to or greater than a fixed value. The drive current is provided by the drive module and enables desired rapid turn-on and off of the power transistor if it is equal to or greater than the fixed value. If the chip is of the buck type, one terminal of the power transistor may be connected to an input pin of the chip (with a voltage varying in a wide range, for example, from 8 V to 120 V). As is well known, the MOS transistor can be turned on once its gate-source voltage (Vgs) reaches a predetermined value (typically, it will be turned on when the absolute Vgs value is greater than 5 V). Moreover, it will be turned off once the gate-source voltage drops to 0. Accordingly, the drive sub-circuit requires a high power supply voltage, which is typically equal to VIN+Vgs or VIN−Vgs. Since the drive sub-circuit operates at a high voltage while the logic sub-circuit operates at a low voltage, it is totally feasible to connect them in series (they can properly operate as long as the input voltage is 8 V or above—assuming that the logic sub-circuit operates at 3 V and that the difference between a voltage of the clamping module 203 in the drive sub-circuit and VIN is kept around 5 V, then after the two sub-circuits are connected in series, proper voltages can be established for them to support normal operation of the various modules in the chip, as long as the input voltage is higher than or equal to 8 V). When the chip is of a high-voltage design (with a nominal operating voltage of 60 V or higher), it will be typically used in 12-V or higher applications, and will be seldom required to provide support to an input voltage on the order of 5 V. Therefore, the chip is highly suitable to operate in the voltage range of from 8 V to 120 V.

Referring to FIG. 2, the drive sub-circuit has a first voltage terminal 2031, a second voltage terminal 2032 and a current output terminal 2033. The first voltage terminal 2031 is configured for connection with the input voltage VIN, and the clamping capacitor is connected between the first voltage terminal 2031 and the second voltage terminal 2032.

During normal operation of the power transistor, at least 90% of the charge current flows successively through the first voltage terminal 2031, the clamping capacitor CC, the second voltage terminal 2032, the current output terminal 2033 and the logic sub-circuit 1.

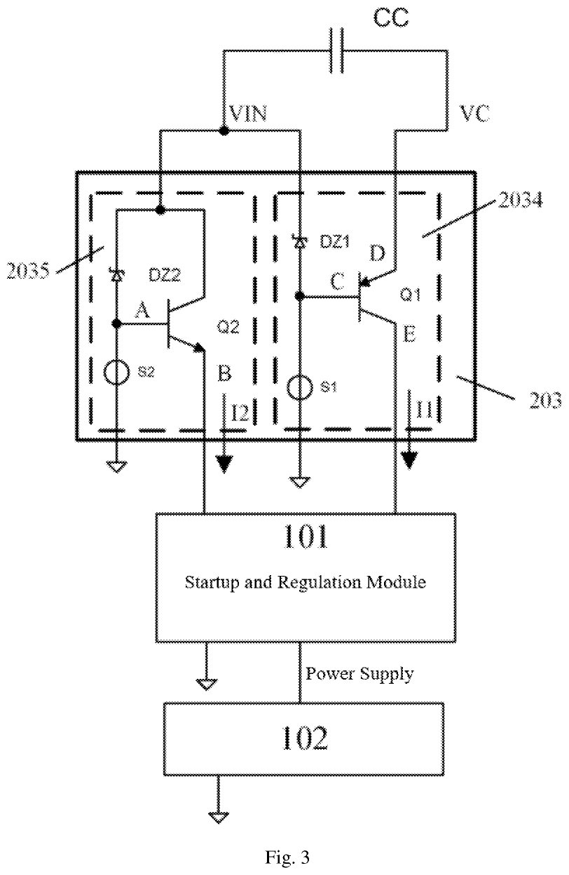

Referring to FIG. 3, the drive sub-circuit includes the clamping module 203, and the first voltage terminal, the second voltage terminal and the current output terminal are all terminals of the clamping module 203. The clamping module includes a first current output unit 2034 and a second current output unit 2035. Output terminals of the first current output unit 2034 and the second current output unit 2035 are interconnected at the current output terminal 2033.

The first current output unit is configured to transfer at least 90% of the charge current (I1 of FIG. 3) to the logic sub-circuit during normal operation of the power transistor, and the second current output unit is configured to provide the logic sub-circuit with a current required for its operation (I2 of FIG. 3) when the power transistor is out of normal operation.

Preferably, the first current output unit is also configured to keep the second current output unit out of operation or minimize its energy consumption during normal operation of the power transistor.

In one specific embodiment, the first current output unit includes a first voltage regulator diode DZ1, a first switching element Q1 and a first constant current source S1. A cathode of the first voltage regulator diode DZ1 is connected to the first voltage terminal 2031, and an input terminal of the first switching element Q1 is connected to the second voltage terminal 2032. A control terminal of the first switching element Q1 is connected to an output terminal of the first voltage regulator diode, and an output terminal of the first switching element Q1 serves as the output terminal of the first current output unit 2034. An input terminal of the first constant current source S1 is connected to the control terminal of the first switching element Q1, and an output terminal of the first constant current source S1 is grounded.

The first switching element is turned on if a voltage difference between its control and input terminals reaches a predetermined value. Otherwise, it remains OFF. For example, if Q1 is a PNP triode, theoretically, it will be turned on when a voltage difference between points D and C is greater than 0.7 V. Accordingly, in this case, the predetermined value is 0.7 V.

The second current output unit includes a second voltage regulator diode DZ2, a second switching element Q2 and a second constant current source S2. A cathode of the second voltage regulator diode DZ2 is connected to the first voltage terminal 2031, and an anode of the second voltage regulator diode DZ2 is connected to a control terminal of the second switching element Q2. An input terminal of the second switching element Q2 is connected to the first voltage terminal 2031, and an output terminal of the second switching element Q2 serves as the output terminal of the second current output unit 2035. The second constant current source S2 is connected between the control terminal of the second switching element Q2 and the ground. Alternatively, the second constant current source S2 may be omitted.

The second switching element Q2 is turned on upon a voltage difference between its control and input terminals reaching a predetermined value. Otherwise, it remains OFF.

A first voltage is higher than a second voltage, the first voltage is a voltage present on the output terminal of the first switching element after it is turned on, the second voltage is a voltage present on the output terminal of the second switching element after it is turned on and the first switching element is turned off. With this arrangement, once the first switching element is turned on, the voltage at the output terminal of the second switching element will be too low to turn on the second switching element. As a result, the second current output unit remains OFF.

In a preferred embodiment, the first switching element is a PNP triode, and the second switching element is an NPN triode. In another preferred embodiment, the first switching element is a PMOS transistor, and the second switching element is an NMOS transistor. Both embodiments allow a simple structure and dispense with any additional supporting elements for adjusting the voltages at the locations.

The clamping capacitor CC is added external to the chip to provide the drive module with a stable voltage and transient current (a large transient current is necessary at the moment when the power transistor is turned on) so that a voltage at the VC pin is equal to a voltage at the VIN pin minus the predetermined value Vgs. It will be understood that this is accomplished by DZ1, Q1 and the constant current source S1. Specifically, when the difference between the voltages at VIN and VC is greater than VDZ1+VBE, Q1 is turned off (Q1 may be a PNP triode, Q1 is turned on when the voltage at point D is VBE higher than the voltage at point C, or Q1 is turned off when the voltage difference is less than VBE). Consequently, the current I1 is 0, and the capacitor CC is not charged anymore. Thus, a voltage at a right plate of CC stops decreasing, thus maintaining the voltage difference between VC and VIN at the fixed value. Upon the power transistor in the chip being turned on, the capacitor CC starts charging the gate-source parasitic capacitance of the power transistor. As the charge on CC is consumed, the voltage at the right plate of the capacitor CC continues rising (a voltage at a left plate is kept at VIN by default) until Q1 is turned on, restoring the current I1. In operation of the chip, the power transistor is turned on and off periodically, causing continuous alternate charging and discharging actions of the capacitor CC. Therefore, the current I1 is kept stable. The chips may be appropriately designed so that when a current desired by the startup and regulation module 101 is equal to I1, the current I1 can ensure normal operation of the entire logic sub-circuit without drawing power from the VIN pin of the chip. In this way, the inherent power consumption of the chip can be reduced by half, compared with the conventional schemes.

However, immediately after the chip is powered on, or when it is repeatedly powered on and off, the amount of charge on the capacitor CC will make the voltage difference between the two plates exactly just equal to VDZ1+VBE. As a consequence, Q1 is OFF, and the current I1 is 0. Since the logic sub-circuit is out of operation, the circuit for driving the power transistor cannot operate due to the absence of a control signal. Consequently, the chip is locked. In order to overcome this, the second current output unit composed of DZ2, Q2 and the constant current source S2 is added. Specifically, when the above problem is encountered immediately following power-on, the current I2 is provided to support operation of the startup and regulation module 101, ensuring proper operation of the logic sub-circuit. As a result, the power transistor in the chip is turned on and off, as desired, enabling proper establishment of the current I1. When DZ2=DZ1, the voltage at point A equals the voltage at point C. In the case of Q2 being implemented as an NPN triode and Q1 as a PNP triode, both triodes Q1, Q2 will operate in their saturation region, resulting in a relatively small C-E voltage difference. Therefore, the voltage at point B is lower than the voltage at point E. Thus, once I1 is properly established, I2 will indefinitely approach 0, substantially without supplying power to the startup and regulation module 101 and hence without causing any additional loss.

In addition, when the parasitic capacitance of the power MOS transistor is relatively small (which means that the current I1 at which the transistor is turned on and off is reduced), the current I1 may be too small to support normal operation of the logic sub-circuit. In this case, DZ2, Q2 and the second constant current source S2 will supplement the current (in case of Q2 being implemented as an NPN triode, if required, the constant current source S2 may be omitted, without affecting operation of Q2 even when no other constant current source is added). Since the voltage at point B is lower than the voltage at point E, the logic sub-circuit will give priority to using the current I1, with the current I2 being treated simply as a supplemental current. Thus, the loss caused by the current I1 can be still eliminated by the series-connection power supply path, reducing the chip's power consumption.

If an external voltage is added to turn off the power MOS transistor in the chip, for example, by applying a high voltage to the FB pin of the chip, the current I1 will approach 0, and the current I2 will instead power the logic module to support normal chip functionality. Additionally, when the external voltage is removed from the FB pin, the chip will resume its normal operation, with the power transistor operating at the predetermined frequency. Meanwhile, I2 will approach 0, and I1 will instead supply power to all the modules. Thus, the series-connection power supply path can still act to reduce the chip's power consumption.

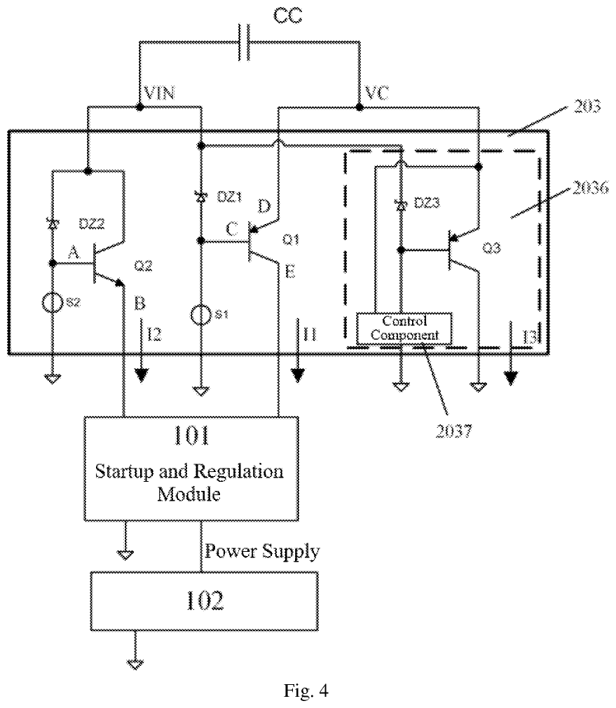

Referring to FIG. 4, in a preferred embodiment, the clamping module 203 further includes a third current output unit 2036, which is configured, when the charge current is greater than the current required for normal operation of the logic sub-circuit, to directly output part of the charge current to the ground so that the remainder of the charge current matches the logic sub-circuit.

In one specific embodiment, the third current output unit 2036 includes a third switching element Q3 and a control component 2037. A terminal of the third switching element Q3 is connected to both the second voltage terminal and the ground.

The control component 2037 is configured to turn on the third switching element Q3, when the third switching element Q3 is OFF and a voltage difference between the first and second voltage terminals is smaller than a first voltage difference. It is also configured to turn off the third switching element Q3, when the third switching element Q3 is ON and the voltage difference between the first and second voltage terminals is greater than a second voltage difference. The first and second voltage differences may be determined based on voltages required for normal operation of the power transistor, and the first voltage difference is smaller than the second voltage difference. For example, the first voltage difference may be related to a lowest allowable level of the clamping capacitor for proper operation of the power transistor, and the second voltage difference may be related to a highest allowable level of the clamping capacitor for proper operation of the power transistor.

The third switching element Q3 may also be a PNP triode, and the third current output unit 2036 may further include a third voltage regulator diode DZ3, the third voltage regulator diode DZ3 is arranged between the first voltage terminal and a control terminal of the switching element. The internal structure of the control component may be properly configured, as desired in practical applications. Moreover, the number of pins on the control component and how they are wired may be properly configured, as desired in practical applications (e.g., as shown in FIG. 4). Further description in this regard is omitted herein.

The clamping module 203 shown in FIG. 4 is suitably usable in more applications. In some cases, the parasitic capacitance of the power MOS transistor is large, requiring a large current for turning on the power transistor. On the other hand, the logic module consumes a substantially fixed level of current. Since I1 passes through the logic sub-circuit before it finally flows to the ground, if the current consumption of the logic sub-circuit is less than the loss caused by the circuit for driving the MOS transistor, the discharge current of CC will exceed the charge current I1. As a consequence, the amount of charge on CC will gradually decrease, resulting in the voltage difference between the plates of CC continually dropping. Once this voltage difference drops below some critical level, the power MOS transistor will fail to be turned on. To prevent this, DZ3, Q3 and the control component 2037 are added to monitor the voltage at the right plate of CC. Upon this voltage dropping below a certain value, Q3 is turned on to additionally charge the clamping capacitor CC with a current I3. A voltage of DZ3 is lower than that of DZ1, and Q3 is turned on periodically. Therefore, I1 remains the main power supply for the chip. After normal operation of the chip is attained, I2 approaches zero, and I3 is a small periodic current. In this case, the charge current for CC may be considered as I1+I3.

Referring to FIG. 1, in the conventional chip, in which the logic and drive sub-circuits are connected in parallel, the logic sub-circuit is powered with a current IQ1 sourced from input power, and the drive sub-circuit is powered with a current IQ2 also sourced from the input power. Accordingly, the chip's inherent power consumption is VIN*(IQ1+IQ2).

In contrast, referring to FIG. 2, in the proposed series-connection-based power supply design, a static current IQ3 is provided by the circuit part for driving the power transistor, which is in turn powered by input power. Therefore, the chip's inherent power consumption is VIN*IQ3.

As an example, assume IQ1=0.5 mA, IQ2=0.5 mA, IQ3=0.5 mA, and the chip operates with no load at an input voltage of 100 V.

According to the present invention, the inherent loss is 100 V*0.5 mA=50 mW.

In contrast, according to the conventional approach, the inherent loss is 100 V*(0.5 mA+0.5 mA)=100 mW.

Therefore, compared with the conventional method, the invention significantly reduces the chip's inherent power consumption and greatly increases its conversion efficiency under light load conditions. As a result, it can generate less heat and provide more output power and improved reliability under high input voltage conditions.

In summary, embodiments described herein provide a power supply circuit and power supply chip. The power supply circuit includes a logic sub-circuit and a drive sub-circuit. The drive sub-circuit is configured to drive a power transistor and is connected in series with the logic sub-circuit so as to commonly share at least part of a current therewith. With this arrangement, the series-connection power supply path allows for current sharing between the logic and drive sub-circuits, which can significantly reduce the chip's inherent circuit losses. Moreover, this optimizes the chip from the perspective of circuit structure, lowering its own power consumption. In preferred embodiments, the series-connection-based design is adapted to various scenarios, achieving additional improvements in reliability and practicality.

Embodiments described herein have benefits as follows: the modules in the chip are powered using a series-connection path, making the chip simple in circuit structure; a current necessary for operation of the on-chip logic sub-circuit or module is provided by the on-chip sub-circuit or module for driving the power transistor and the off-chip clamping capacitor (for energy storage and provision of transient currents), achieving current sharing, which avoids the loss caused by current consumption in one of the sub-circuits; and the internal components of the chip can be powered with less power consumption.

The description presented above is merely that of a few preferred embodiments of the present invention and does not limit the scope thereof in any sense. Any and all changes and modifications made by those of ordinary skill in the art based on the above teachings fall within the scope as defined in the appended claims.

1. A power supply circuit, comprising a logic sub-circuit and a drive sub-circuit, the drive sub-circuit configured to drive a power transistor, the logic sub-circuit and the drive sub-circuit connected in series so as to share at least part of a current,
the drive sub-circuit configured to charge a clamping capacitor, the clamping capacitor configured to store charge in an amount sufficient to quickly charge parasitic capacitance of the power transistor and hence rapidly turn on the power transistor with a charge current, at least 90% of the charge current of the clamping capacitor is commonly shared by the logic sub-circuit and the drive sub-circuit.

2. The power supply circuit according to claim 1, wherein the drive sub-circuit comprises a first voltage terminal, a second voltage terminal and a current output terminal, the first voltage terminal configured for connection with an input voltage, wherein the clamping capacitor is connected between the first voltage terminal and the second voltage terminal, and
during normal operation of the power transistor, at least 90% of the charge current flows successively through the first voltage terminal, the clamping capacitor, the second voltage terminal, the current output terminal and the logic sub-circuit.

3. The power supply circuit according to claim 2, wherein the drive sub-circuit comprises a clamping module, wherein the first voltage terminal, the second voltage terminal and the current output terminal are all terminals of the clamping module; the clamping module comprises a first current output unit and a second current output unit; an output terminal of the first current output unit and an output terminal of the second current output unit are connected to each other and together provide the current output terminal;
the first current output unit is configured to transfer at least 90% of the charge current to the logic sub-circuit during normal operation of the power transistor; and the second current output unit is configured to provide a current necessary for operation to the logic sub-circuit when the power transistor is out of normal operation.

4. The power supply circuit according to claim 3, wherein the first current output unit is also configured to keep the second current output unit out of operation, or minimize energy consumption of the second current output unit during normal operation of the power transistor.

5. The power supply circuit according to claim 3, wherein the first current output unit comprises a first voltage regulator diode, a first switching element and a first constant current source, a cathode of the first voltage regulator diode connected to the first voltage terminal, an input terminal of the first switching element connected to the second voltage terminal, a control terminal of the first switching element connected to an anode of the first voltage regulator diode, an output terminal of the first switching element serving as the output terminal of the first current output unit, an input terminal of the first constant current source connected to the control terminal of the first switching element, an output terminal of the first constant current source being grounded,
wherein the first switching element is turned on if a voltage difference between the control terminal and the input terminal of the first switching element reaches a predetermined value, and otherwise remains off.

6. The power supply circuit according to claim 5, wherein the second current output unit comprises a second voltage regulator diode and a second switching element, a cathode of the second voltage regulator diode connected to the first voltage terminal, an anode of the second voltage regulator diode connected to a control terminal of the second switching element, an input terminal of the second switching element connected to the first voltage terminal, the output terminal of the second switching element serving as the output terminal of the second current output unit,
wherein the second switching element is turned on if a voltage difference between the control terminal and the input terminal of the second switching element reaches a predetermined value, and otherwise remains off, and
wherein a first voltage is higher than a second voltage, the first voltage is a voltage present on the output terminal of the first switching element after it is turned on, the second voltage is a voltage present on the output terminal of the second switching element after the first switching element is turned off and the second switching element is turned on.

7. The power supply circuit according to claim 3, wherein the clamping module further comprises a third current output unit, when the charge current is greater than the current necessary for normal operation of the logic sub-circuit, the third current output unit is configured to directly output part of the charge current to the ground so that the remainder of the charge current matches the logic sub-circuit.

8. The power supply circuit according to claim 7, wherein: the third current output unit comprises a third switching element and a control component,
a connection terminal of the third switching element is connected to both the second voltage terminal and ground; and
the control component is configured to: turn on the third switching element when the third switching element is off and a voltage difference between the first voltage terminal is smaller than a first voltage difference; and turn off the third switching element when the third switching element is on and the voltage difference between the first voltage terminal is greater than a second voltage difference, wherein the first voltage difference and the second voltage difference are determined based on voltages required for normal operation of the power transistor, and the first voltage difference is lower than the second voltage difference.

9. A power supply chip, comprising the power supply circuit of claim 1.
